(19) United States
(12) Patent Application Publication
(10) Pub. No.: US 2002/0056470 A1
(43) Pub. Date: May 16, 2002

(54) Equipment washing and drying machine

(76) Inventor: Michel Huot, Lorraine (CA)

Correspondence Address: George A. Seaby, 603-880 Wellington Street, Ottawa, ON, K1R 6K7, CA

(21) Appl. No.: 09/987,789

(22) Filed: Nov. 16, 2001

(30) Foreign Application Priority Data
Nov. 16, 2000 (CA) 2,325,771
Nov. 16, 2000 (CA) 2,325,772

(51) Int. Cl. B08B 3/00

(52) U.S. Cl. 134/95.2; 134/159; 134/155

(57) ABSTRACT

A machine for washing and drying equipment and in particular impermeable sports equipment includes a housing with an opening through which pieces of equipment are placed radially into compartments of a partitioned carrier. The carrier is rotatably mounted in a fixed drum, which receives washing liquid and then hot air for washing and drying the pieces of equipment. Partitions in the carrier can be adjusted to form small or large compartments, which receive one or more pieces of equipment and hold the pieces separate from those in other compartments during washing and drying.

### BACKGROUND OF THE INVENTION

1. Field of the Invention

This invention relates to a machine for washing and drying equipment, and in particular to a machine for washing and drying impermeable sports equipment.

While the machine was designed primarily for washing impermeable sports equipment such as shoulder and shin pads, it will be appreciated that the machine can be used to wash other equipment.

2. Discussion of the Prior Art

In basic terms, the machine of the present invention is designed to receive individual or small numbers of articles in discrete compartments for washing and drying. Machines of this type are by no means new. Examples of machines of the type in question are disclosed by Canadian Patent Application No. 2,280,341, filed in the name of R. J. Rhode et al on Aug. 18, 1999, and U.S. Pat. No. 2,431,418, issued to J. Olen on Nov. 25, 1947; U.S. Pat. No. 3,956,791, issued to W. Rutten on May 18, 1976; U.S. Pat. No. 4,370,992, issued to H. Choudhury et al on Feb. 1, 1983 and U.S. Pat. No. 5,413,132 issued to T. Cronan on May 9, 1995. It is also known to place articles in small containers, and then insert the container into a washer or dryer. In this connection, reference is made to U.S. Pat. No. 4,109,397, issued to T. E. Daily on Aug. 29, 1978; U.S. Pat. No. 4,617,743, issued to R. Barnard on Oct. 21, 1986; U.S. Pat. No. 4,702,016, issued to S. H. Grigsby et al on Oct. 27, 1987 and U.S. Pat. No. 5,743,025, issued to R. W. Jordan, Jr. on Apr. 28, 1998.

For the most part, machines of the above described type, i.e. machines for receiving articles in discrete compartments require the loading of articles to be cleaned into baskets or other containers, which are placed in the machine for washing and unloaded from the machine following cleaning. Thus, a washing operation is somewhat labour intensive and time consuming. Moreover, in order to avoid the risk of individual articles rattling around in the containers, it is necessary either to tailor make the containers to suit the articles, i.e. make different size containers for different articles, or to place the articles in smaller containers, which then go into larger containers and finally into the machine.

### GENERAL DESCRIPTION OF THE INVENTION

The object of the present invention is to overcome the problems outlined above by providing a relatively simple washing and drying machine containing adjustable, article-receiving compartments.

Accordingly, the invention is a machine for washing and drying equipment comprising:

(a) a housing;

(b) a drum fixedly mounted in said housing;

(c) a cylindrical carrier rotatably mounted in said drum for receiving pieces of equipment;

(d) a plurality of discrete compartments in said carrier for receiving one or more pieces of equipment, each said compartment having an adjustable volume for accommodating pieces of a variety of sizes;

(e) a liquid inlet for introducing washing fluid into said drum;

(f) a drive for rotating said carrier in said drum whereby articles in said carrier are washed during rotation of the carrier in said drum;

(g) a liquid outlet for discharging washing fluid from the drum;

(h) an air inlet in said drum for introducing air into the drum to dry any contents thereof; and

(i) an air outlet in said drum for discharging fluid from the drum.

### BRIEF DESCRIPTION OF THE DRAWINGS

A preferred embodiment of the invention is described below in detail with reference to the accompanying drawings, wherein:

FIGS. 1 and 2 are perspective views of a washing and drying machine as seen from the front in the open and closed conditions, respectively;

FIG. 3 is a cross section of the machine of FIGS. 1 and 2 with the rear wall removed;

FIG. 4 is a longitudinal sectional view of the machine of FIGS. 1 and 2;

FIG. 5 is an exploded, isometric view of most of the interior elements of the machine of FIGS. 1 and 2;

FIG. 6 is an exploded, isometric view of a frame carrying a drum used in the machine of FIGS. 1 and 2;

FIG. 7 is an exploded, perspective view of water inlet and discharge systems used in the machine of FIGS. 1 and 2;

FIG. 8 is a rear view of the machine with the rear wall removed;

FIG. 9 is a side view of the machine with a side wall removed;

FIG. 10 is an isometric view of an article carrier used in the machine;

FIG. 11 is an exploded, isometric view of a bracket and one end of a crossbar used in the carrier of FIG. 10;

FIG. 12 is an isometric view of a portion of a door assembly used on the carrier;

FIG. 13 is an isometric view of the center of one panel of the door assembly;

FIG. 14 is a cross-sectional view of a shelf assembly used in the carrier of FIG. 10;

FIG. 15 is a top view of an individual shelf used in the assembly of FIG. 14;

FIG. 16 is a partly exploded, side view of the shelf of FIG. 15; and

FIGS. 17 and 18 are side views of two different partitions used in the assembly of FIG. 14.

It will be appreciated that most of the figures of the drawings are schematic, and, for the sake of simplicity, parts have been omitted from some of the figures.

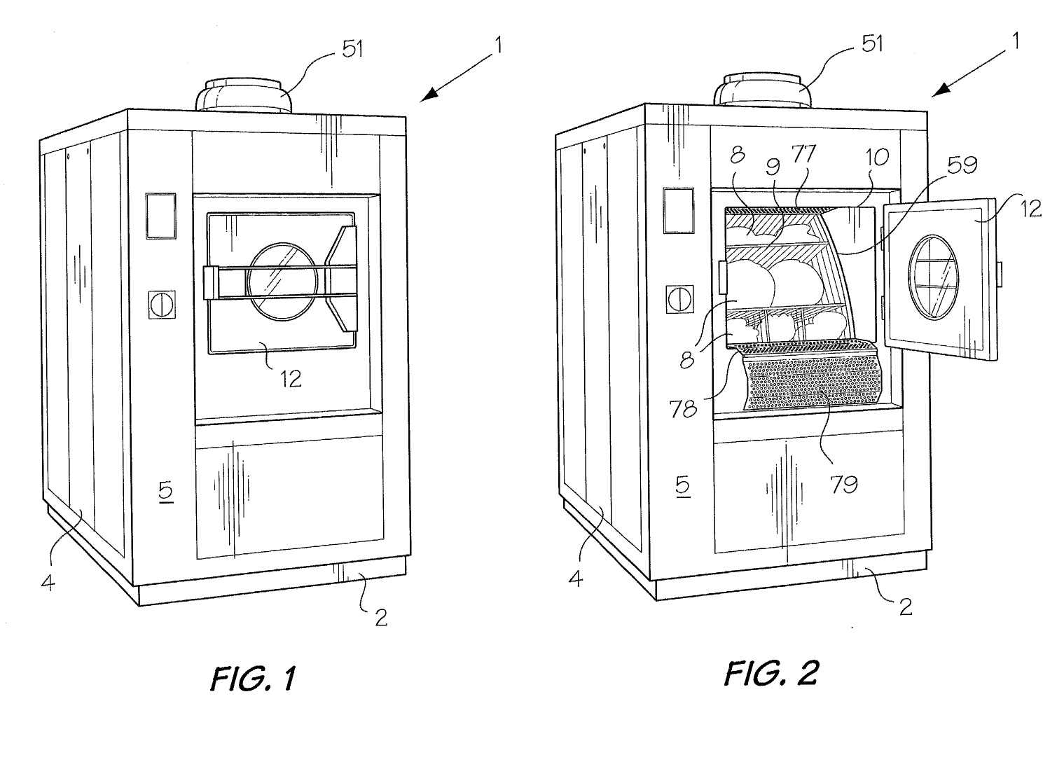

Referring to FIGS. 1 and 2, the machine of the present invention includes a rectangular, parallelepipedic housing indicated generally at 1 mounted on a rectangular base 2. The housing 1 is defined by a top wall 3, side walls 4, a front wall 5 and a rear wall 6. Articles 8 to be washed are inserted into the basket assemblies 9 in the housing 1 via an opening 10 in the front wall 5. A door 12 closes the opening 10 during washing and drying operations.

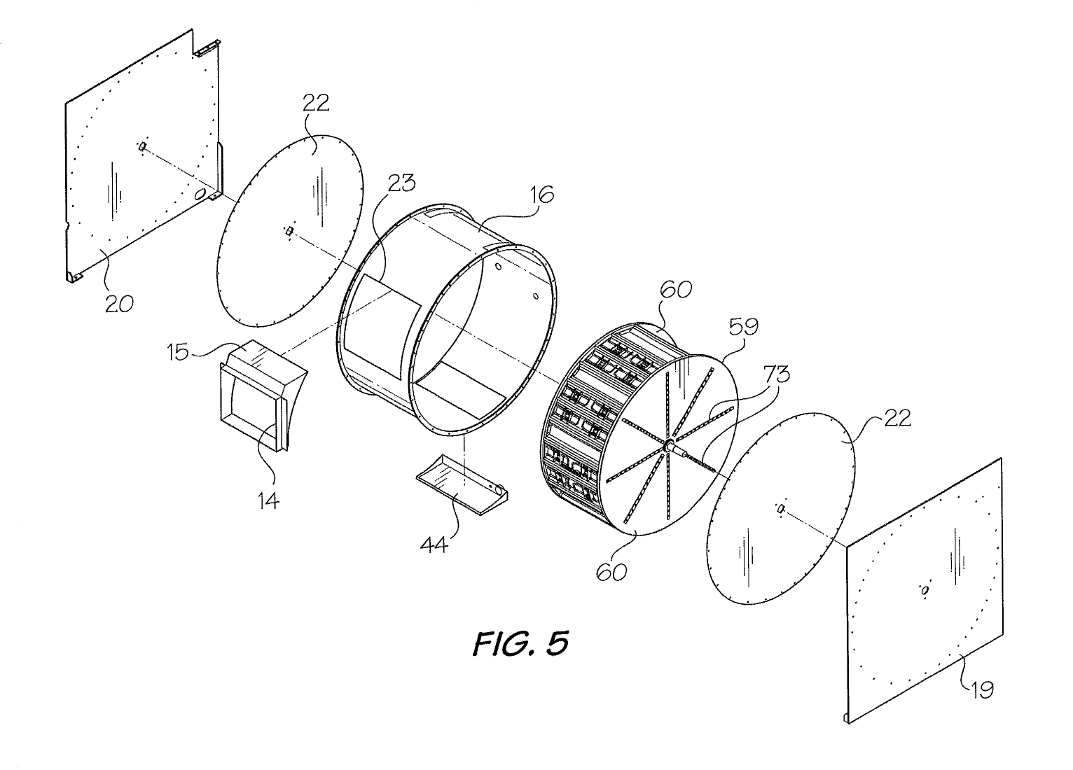

Hinges 13 pivotally mount the door 12 for rotation between closed and open positions (FIGS. 1 and 2, respectively) on a flange 14 extending outwardly from a cowl 15 mounted on a drum 16 in the casing 1. The drum 16 is fixedly mounted in a frame defined by a pair of partitions 19 and 20 mounted on the base 2 using annular flanges 21 defined by the peripheries of the circular ends 22 of the drum 16 and bolts (not shown). The cowl 15 extending outwardly from an opening 23 (FIG. 5) in the front periphery of the drum 16 includes a rectangular opening 23 through which articles 8 are loaded into the drum 16.

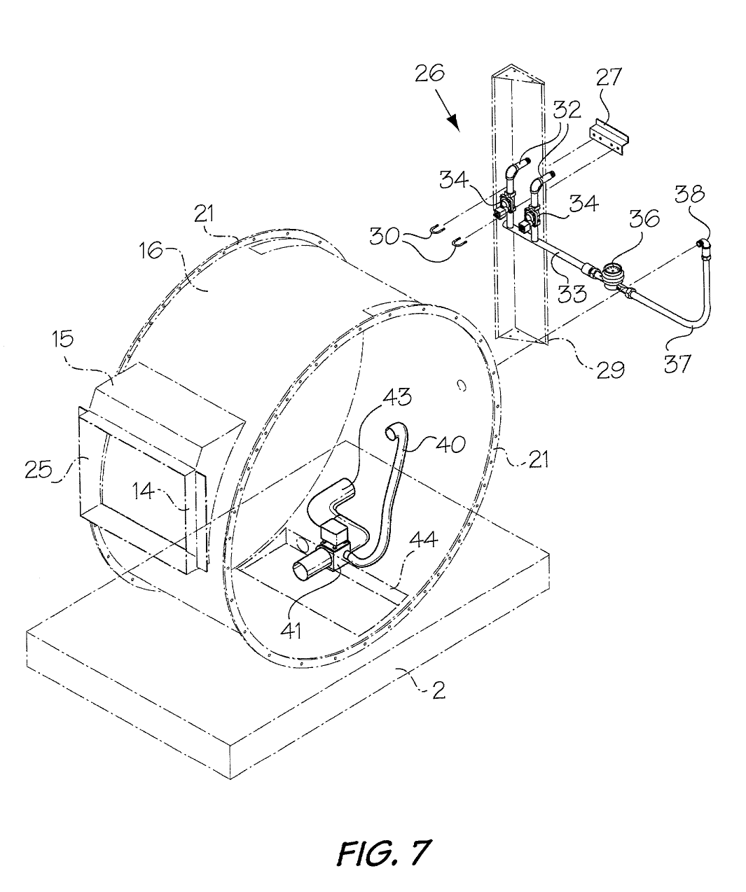

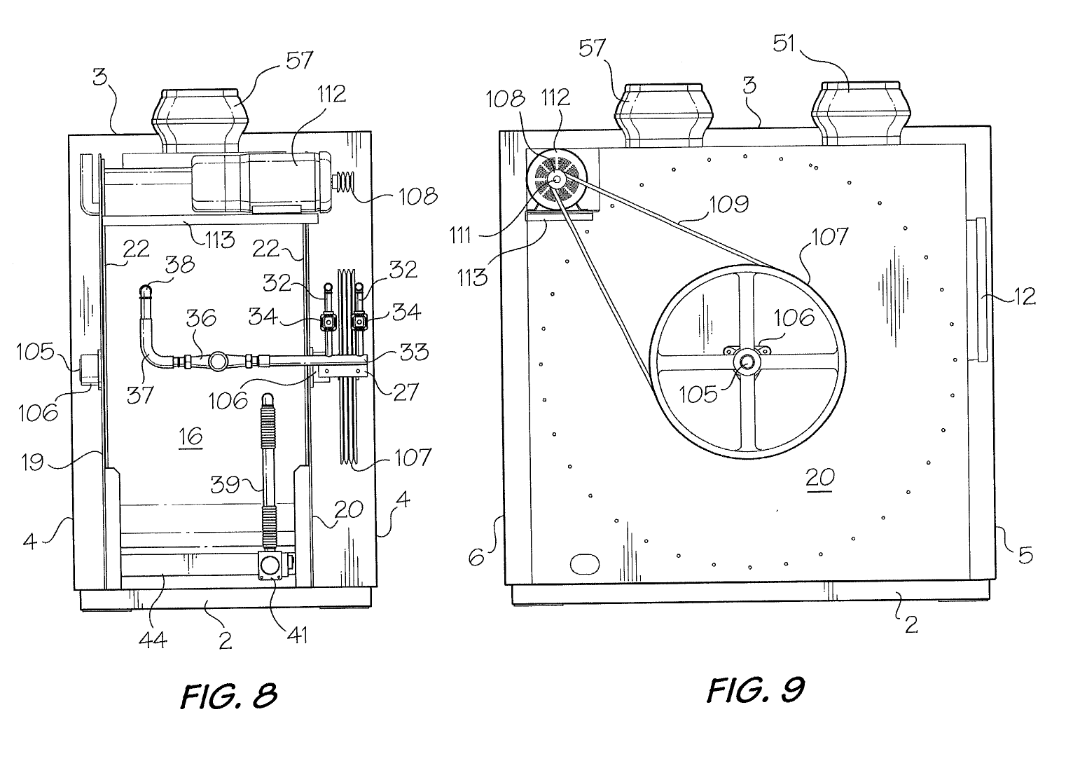

As best shown in FIGS. 7 and 8, during a washing cycle, water is introduced into the drum 16 via an inlet assembly indicated generally at 26 supported in the housing by a bracket 27 extending outwardly from a triangular frame 29 at the rear of the housing 1. The inlet assembly 26 is mounted on the bracket 27 using U-bolts 30 and nuts (not shown). The assembly 26 includes hot and cold water pipes 32 connected to a mixing manifold 33 by solenoid valves 34, a flow meter 36 for receiving water from the manifold 34, and a generally L-shaped pipe 37 connected to the rear of the tank 16 by an elbow 38 and a pipe 39 (FIG. 4). Water in the tank 16 is prevented from rising above a predetermined level by an overflow pipe 40 connected to the rear of the tank 16, and to a pump 41 which discharges water to a drain (not shown) via a pipe 43. During normal draining of the tank 16, water is discharged via a trough 44 in the bottom of the drum 16, the pump 40 and the pipe 43.

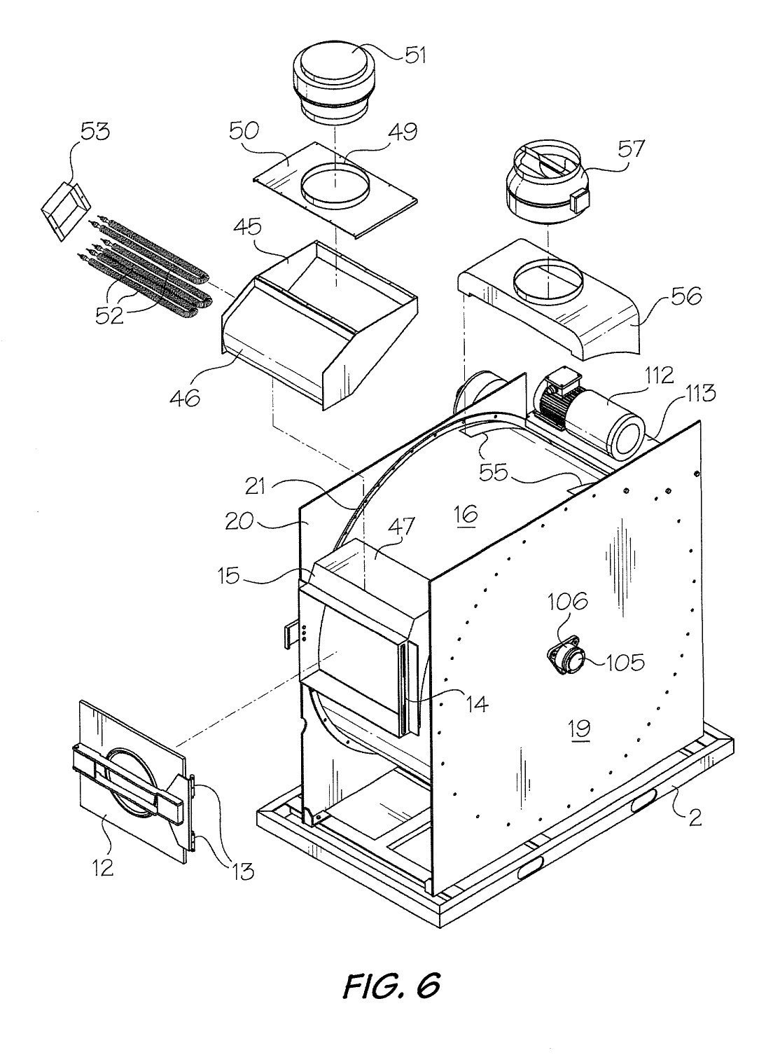

With particular reference to FIGS. 4 and 6, air is introduced into the drum 16 to dry articles therein via a heating chamber 45 in a casing 46 mounted on the open top end 47 (FIG. 6) of the cowl 15. The casing 46 has an opening 49 in the top wall 50 thereof for receiving air from a fan 51 mounted on the top wall 3 of the housing 1. Air entering the casing 46 is heated by a plurality of generally U-shaped electrical heating elements 52 supported by a cover 53. Air is discharged from the drum 16 through a pair of openings 55 in the top rear of the drum 14, a manifold 56 and a fan 57 on the top rear of the housing 1.

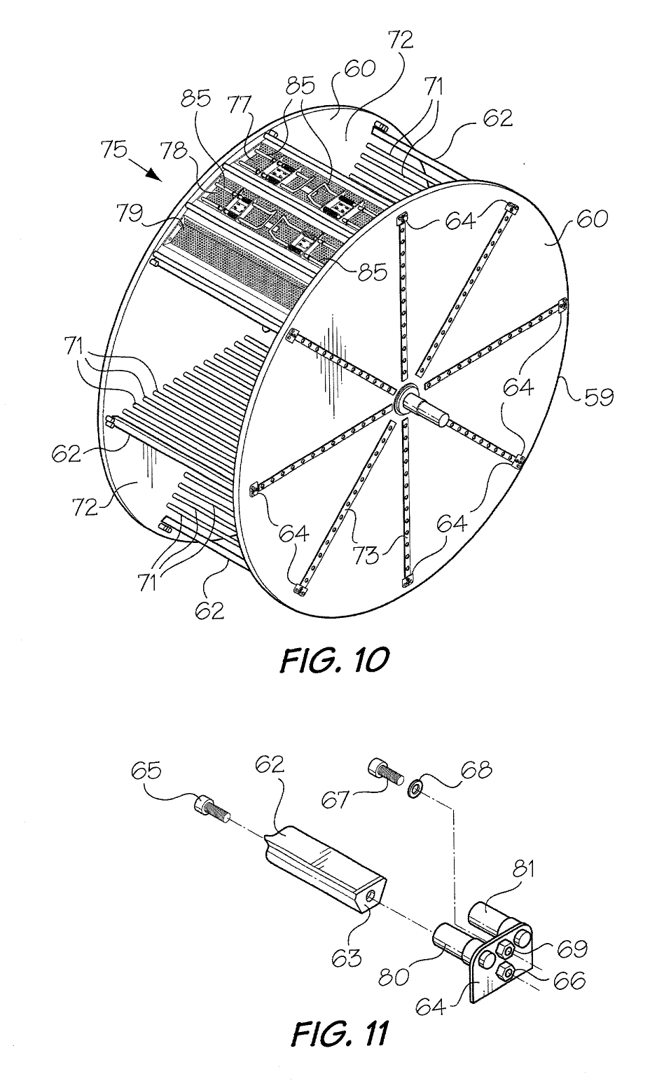

With reference to FIGS. 2, 5 and 10 to 12, a cylindrical article carrier 59 is rotatably mounted in the drum 16. The carrier 59 includes a pair of circular ends 60 interconnected by a plurality of cross bars 62. The ends 63 of the hollow crossbars 62 are connected to brackets 64 by bolts 65 and nuts 66 (FIG. 11). The brackets 64 are connected to the carrier 59 by bolts 67, washers 68 and nuts 69. A plurality of tubular bars 71 extend between the ends 60. The bars 71 are arranged in radially extending rows spaced 45° apart defining eight separate segments or compartments 72. The bars 71 in each row are spaced apart to permit substantially unimpeded fluid flow in the drum 16. The bars 71 extend through the ends 60 into reinforcing strips 73 on the outer surfaces of the ends 60. The strips 73 obviate the need for washers on the ends of the bars 71.

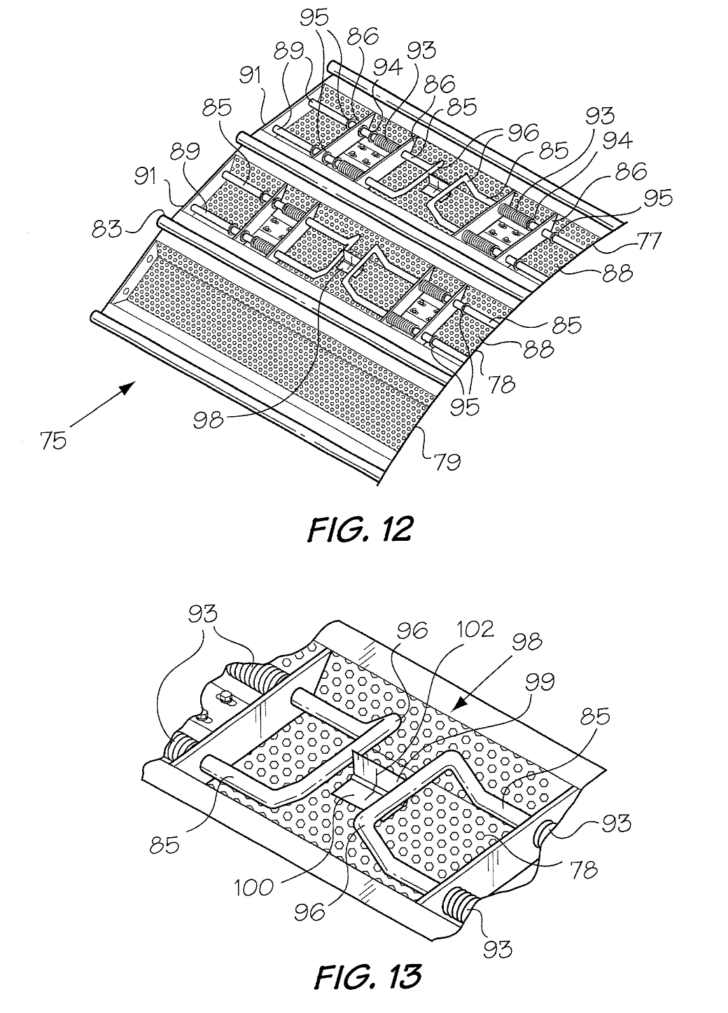

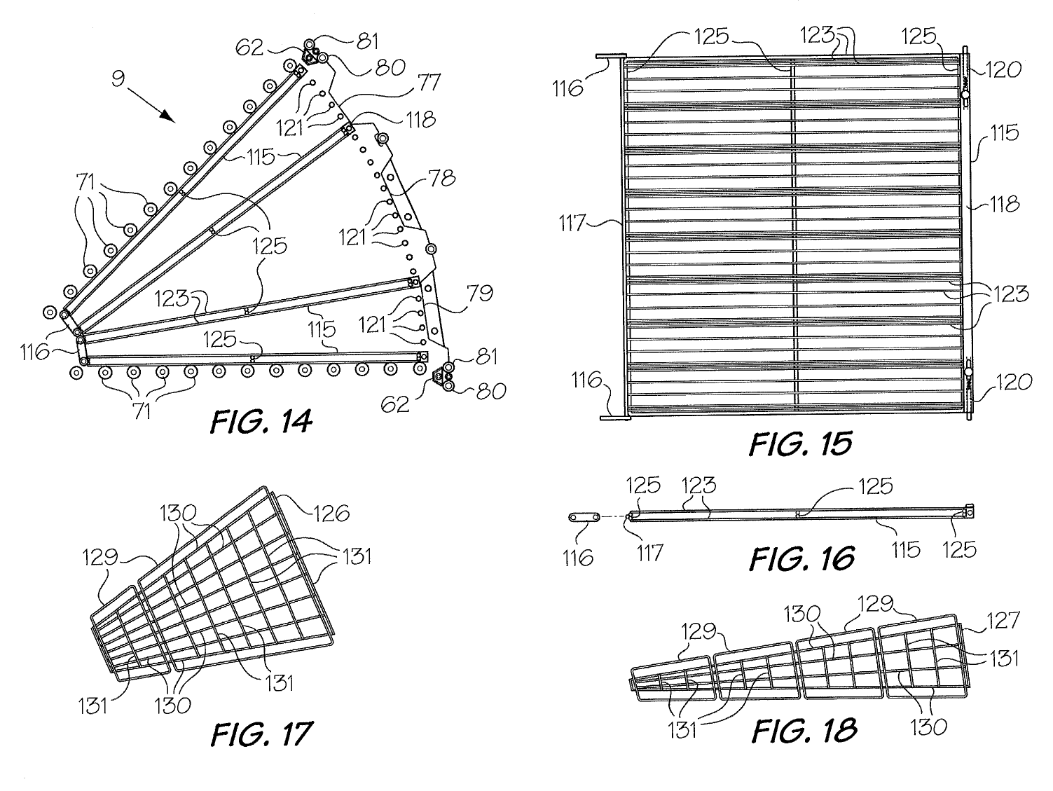

The periphery, i.e. the open outer end of each compartment 72 is closed by doors indicated generally at 75. The doors 75 are defined by panels 77, 78 and 79. The panels 77 and 79 are pivotally mounted on pins 80 and 81, respectively extending inwardly from the brackets 63 on each end 60 of the carrier 59. Thus, the panel 77 closes approximately one-third of the outer end of a compartment 72, and the panels 78 and 79 closes the remainder of such outer end, and in the closed position (FIGS. 12 and 14), the arcuate free end of the panel 78 overlaps the free end of the panel 77. The panel 78 is pivotally connected to the panel 79 by a hinge 83. Each of the panels 77, 78 and 79 is perforated to permit the flow of fluid therethrough. A pair of latch mechanisms are mounted on both of the panels 77 and 78. Each latch mechanism includes a generally U-shaped rod 85 slidably mounted in plates 86 extending across longitudinally extending recesses 88 in the panels 77 and 78. The arms 89 of the rod 85 define bolts for sliding through end plates 91 on the panels 77 and 78 into holes (not shown) in the ends 60 of the carrier 59 for releasably locking the door 75 in closed position. The bolts 89 are biased to the locked position by springs 93 on the rod 85 between the plates 86 and C-clips 94 on the rods. Other C-clips 95 limit movement of the rod 85 between the locked and release positions. The inner ends of the rods 85 are bent outwardly to define easily accessible handles 96.

In order to load a compartment 72, the rods 85 are pulled inwardly towards each other to release the door 75. After loading has been completed, the panels 77, 78 and 79 are returned to the closed position. During closing, the rods 85 are pulled inwardly to clear the ends 60 of the carrier 59 and then released into the holes in such ends. Indicator strips 98 (FIG. 13) are mounted on the center of the panel 78 for providing a visual indication of whether the doors 75 are closed so that washing and drying operations can be started. When the latch mechanisms are in the release position, a red indication strip 99 is visible. When the rods 85 move to the locked position, the red strip 99, which is pivotally connected to a green strip 100, is rotated by a spring 102 to an extended position more or less perpendicular to the panel 78 exposing the green strip 100 which indicates that the door is locked closed. The green strip 100 is mounted on the center of the panel 78. In the locked position, the red strip 99 extends between the handles 96 of opposed rods 85, preventing unlocking of door 75 until the machine is stopped, and the red strip 99 manually returned to a position beneath the handles 96.

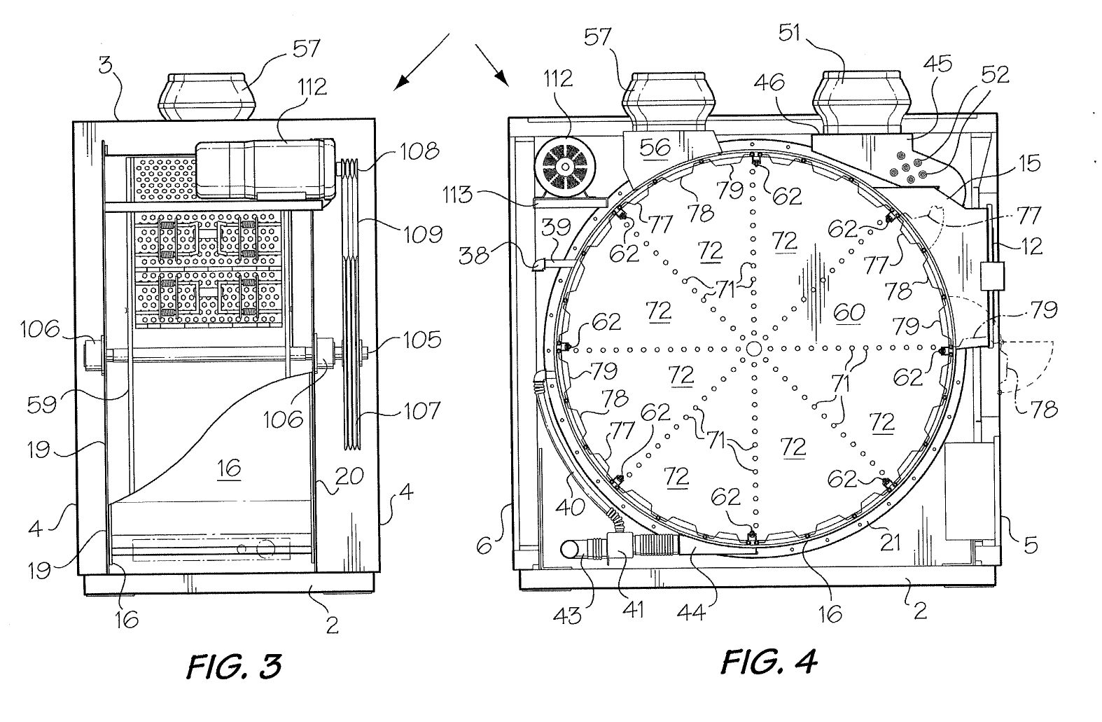

A shaft 105 extends through the centers of the ends 60 of the carrier 59 and through bearings 106 (FIGS. 3, 8 and 9) on the partitions 19 and 20. One end of the shaft 105 carries a large pulley 107, which is connected to a smaller pulley 108 by V-belts 109. The pulley 108 is mounted on the outer end of the shaft 111 of an electric motor 112. The motor 112 is supported by a platform 113 (FIGS. 3, 4, 6 and 9) on the top rear of the frame defined by the partitions 19 and 20. When the motor 112 is running, the article carrier 59 is caused to rotate in the drum 16 so that the articles in the carrier repeatedly pass through water in the drum 16 or water is expelled through the doors 75 during spinning and drying cycles of the machines.

Referring to FIGS. 2 and 14 to 18, the grid-like basket assemblies 9 in each compartment 72 are defined by two pairs of shelves 115 formed of plastic coated wire. The shelves 115 of each pair of shelves are pivotally interconnected at their inner ends by pivot arms 116. The pivot arms 116 are pivotally connected to the free ends of crossbars 117 at the inner ends of adjacent shelves 115. Because both ends of each pivot arm 116 is pivotally connected to the shelves 115, the outer ends 118 of the shelves can be rotated to a variety of positions while maintaining the radial distance of the outer ends of the shelves 115 from the center of the carrier 59. The outer ends 118 of the shelves 115 carry bolt locks 120 for releasably locking the shelves in a variety of positions, i.e. for changing the spacing between the shelves 115. The bolt locks 120 engage recesses 121 (FIG. 14) in the inner surface of the ends 60 of the carrier 59. The spacing between the shelves 115 is changed for receiving different sports equipment, e.g. hockey or football helmets, shoulder pads, shin pads, etc.

Each shelf 115 includes a plurality of parallel, spaced apart, longitudinally extending rods 123 interconnected by crossbars 125. The rods 123 are arranged in two layers spaced apart by a pair of crossbars 125. Selected rods 123 are close together for receiving partitions 126 or 127. Each partition 126 and 127 is defined by a plurality of trapezoidal wire frames 129 interconnected by longitudinally extending rods 130 and crossbars 131, all of which are formed of plastic coated wire. The thickness of the partitions 126 and 127 is slightly less than the spacing between the rods 123 which are closest to each other, so that the partitions remain vertical when inserted between the rods 123. Moreover, the length of the wire frames 129 is such that one, or in the case of the partition 127, two trapezoids fit tightly between the middle and outermost or front crossbars 125 of the shelves 115. With this arrangement of shelves 115 and partitions 126 and 127, compartments of various sizes can readily be formed to snugly receive a variety of pieces of sports equipment.

The operation of the machine is controlled electronically, and is essentially the same as that as that of a conventional washer/dryer.

I claim:

1. A machine for washing and drying equipment comprising:
(a) a housing;
(b) a drum fixedly mounted in said housing;
(c) a cylindrical carrier rotatably mounted in said drum for receiving pieces of equipment;
(d) a plurality of discrete compartments in said carrier for receiving one or more pieces of equipment, each said compartment having an adjustable volume for accommodating pieces of a variety of sizes;
(e) a liquid inlet for introducing washing fluid into said drum;
(f) a drive for rotating said carrier in said drum whereby articles in said carrier are washed during rotation of the carrier in said drum;
(g) a liquid outlet for discharging washing fluid from the drum;
(h) an air inlet in said drum for introducing air into the drum to dry any contents thereof; and
(i) an air outlet in said drum for discharging fluid from the drum.

2. The machine of claim 1, including a door on said housing for accessing said carrier; and perforated panels on the periphery of said carrier for closing said compartments.

3. The machine of claim 2, including a lock on selected of said panels for locking all of the panels in closed positions.

4. The machine of claim 2, wherein said carrier includes grid-like basket assemblies of adjustable volume for receiving pieces of equipment while permitting the free flow of fluid in the carrier.

5. The machine of claim 4, wherein said carrier includes circular ends; spaced apart bars extending between said ends in radial rows, said bars dividing the area between said ends into separate segments, each segment containing one said basket assembly.

6. The machine of claim 5, wherein each said basket assembly includes movable shelves in each said segment; and movable partitions releasably interconnecting said shelves, both said shelves and partitions being grid-like to permit the free flow of fluid in the carrier.

7. The machine of claim 5, including a latch on each said shelf for releasably locking the shelf in one of a plurality of fixed positions in said carrier, whereby the volume of said compartments can readily be altered.

8. The machine of claim 1, including a heater in said air inlet for heating air entering said drum.

9. The machine of claim 1, wherein said air inlet includes an inlet fan on the front of a top wall of said housing; and a cowl on said drum containing said heater for transferring air from said fan to said drum.

10. The machine of claim 9, wherein said air outlet includes openings in the top rear of the drum, a manifold for receiving air from said openings, and an outlet fan on the rear of said top wall of the housing for receiving fluid from said manifold.
